(19) United States
(12) Patent Application Publication
(10) Pub. No.: US 2005/0121214 A1
(43) Pub. Date: Jun. 9, 2005

(54) Active electrical transmission system

(76) Inventor: Len Charles Gould, Brampton (CA)

Correspondence Address: Mr. Len C. Gould, 43 Copeland Road, Brampton, ON, L6Y 2S5, CA

(21) Appl. No.: 10/726,576

(22) Filed: Dec. 4, 2003

(51) Int. Cl. H02G 7/00

(52) U.S. Cl. 174/40 R

(57) ABSTRACT

An electrical transmission line is provided which employs the conductive and structural material usually formed into current carrying cables to form the tubes of a pressurized pipeline which is then suspended from insulators on tall poles to create a low impedance electrical conductor and a high volume gas pipeline. The poles of wind generator towers may be employed to support the conductors and to store the gas from the pipeline. Auxiliary electrical generation may be added at the towers to assist in voltage or VAR support at times of peak load. Electrolysers may also be employed to increase electrical power consumption during offpeak times and supply the fuel gas or compressed air generated into the pipeline for sale or into storage for later re-conversion back into electricity at times of peak demand. A novel line layout plan is provided which reduces the cost of the transmission line.

### BACKGROUND OF THE INVENTION

This invention applies to high voltage electrical power transmission systems.

It is known to employ tubular conductors to transfer electrical power. Micheal W. Dew in U.S. Pat. No. 4,947,007 teaches the construction of an overhead superconducting transmission line in which the conductors are also tubes within a sheath tube, again for the purpose of supplying over very short sections of the line the cryogenic liquid required to maintain the conductors cold enough to acquire their superconductivity. No other purpose of the tubes is contemplated.

Filmore O. Frye, in U.S. Pat. No. 5,565,652 teaches the construction of an electrical transmission line from conductive pipes laid within insulating plastic pipes. However no use is contemplated of the resulting pipeline to tranport any physical material and, in fact, this would be impossible in a line constructed according to his specification since in long straight runs the couplings are not tightly joined in order to provide for thermal expansion of the interior conducting pipe. Also no suspension of the conductor design from overhead supports is contemplated or possible.

Herrmann et al in U.S. Pat. No. 5,859,386 describe how to use tubular superconducting conductors with the tubes fill d with a cryogenic fluid to reduce resistance caused losses at points of fairly short transfer of very heavy currents such as between a power generator and the transmission transformer which it feeds. The superconducting tube is surrounded outside with a larger tube which is maintained at a vacume for thermal insulation purposes, and lined inside with a smaller tube which conducts the cryogenic coolant, presumeably due to pressure handling restrictions or joint sealing problems with the superconducting material.

Christer Arnborg, in U.S. Pat. No. 6,433,271 teaches the use of tubular busbars to interconnect cells of high voltage switchgear in substations. The reasons for the use of tubular conductors is to simplify busbar connection during manufacture or maintenance, to enable forced or convective cooling of the conductors, and to reduce voltage gradients in the air around the conductors.

### BRIEF SUMMARY OF THE INVENTION

The present invention is intended to optimize from an economic viewpoint the use of materials in construction of a high voltage electrical transmission system.

The minimum requirements of an overhead electrical transmission line are a series of strong tall vertical support structures and a set of electrical conductors suspended on insulators from the vertical supports. These requirements happen to also coincide with the requirements for electrical generating wind turbines.

It is an object of the present invention to gain economic advantage by substituting the towers of new high voltage transmission lines with the tall and sturdy towers typically used to support large wind turbines. The somewhat sub-optimal siting of the turbines e.g. being required to follow the route of the transmission corridor, can be justified economically by the reductions in capital cost of installation achieved by sharing the towers with the transmission line, and also slightly by making taller towers economically justifiable which improves the performance of a wind turbine.

A further object of the present invention is to gain economic advantage by installing at some or all of the wind generators mounted on the transmission line towers an auxiliary electrical generating system to supplement the wind turbine power output during periods of peak demand of the customers serviced by the transmission line. It is unfortunate that wind power is a notoriously unreliable power source, typically providing on average less than 33% of the rated output of the generator. Installing a heat engine onto the gearbox of the wind turbine would add only a small percentage of weight and cost to the installation while enabling the turbine to then guarantee full rated output during peak demand periods. As an alternative, if the supplemental power wire provided by typical fuel cells then the added weight can be removed from the top of the tower and no special connections to the wind turbine gearbox would be required.

It is a further object of the present invention to overcome the remaining difficulty of supplying the required fuel to the heat engines or fuel cells. A standard fuel pipeline infrastructure for a remote wind generator farm is difficult to justify economically. However, one simplified definition of a suitable pipeline is “an amount of high strength material, usually metal, forming an elogated connection between two or more points.” This definition also happens to describe the electrical conductors of a high voltage transmission line, which are usually aluminum conductors steel reinforced, or ACSR cables. If the aluminum of these conductors were improved in tensile strength in any of several well-known ways such as being alloyed with one or two percent magnesium, and then formed into a tube, and additional tensile strength were provided by paralleled steel cables, a pipeline can be created which can be hung from the insulators of a high voltage transmission tower to act as both an electrical conductor and a fuel gas pipeline.

In a first preferred embodiment of the present invention, 8 aluminum tubes 140 mm diameter (nominal 5″) and having 2.5 mm thick walls and supported by 8 steel cables each having a 125 square millimeter cross section, all suspended on towers spaced at 450 meter intervals with a 9% sag can transmit 2.8 gigawatts electrical for 1000 kilometers with only 3.68% electrical losses at 1000 KV DC. The 1000 KV DC is transmitted as 500 KV+ on one side of the tower and 500 KV− on the other side, thus reducing the stress on the supporting insulators to the same as would be seen on a 345 KV AC line. These same pipes operating at 68 bar (1000 psi) can also transmit 1133 megawatts of Natural Gas fuel at 1.33% compression losses per 160 km. Further, having 75% of the towers each carry a 1.5 megawatt wind turbine supplemented by an auxiliary 1.5 megawatt gas turbine engine, an additional 2.5 gigawatts of dispatchable peak power and (at 30% wind reliability) an additional 0.55 gigawatts of off-peak wind generated power is available to sell at the end of the line. The incremental capital cost of the fuel supplemented wind generation is approximately one to one point five million dollars per megawatt above the cost of a standard electrical transmission line. The power generated by the wind turbines is transmitted between towers at nominal 30 Kv AC generator voltage, or as comparable voltage DC, on an underhung set of secondary conductors until sufficient capacity is available to justify a step-up connection to the main transmission conductors. Benefits include a) reduced fuel cost because a part of the added power (8% of peak power, 100% offpeak) is wind generated, b) improved return on capital invested in wind generators due to improved capacity factor, c) significant reduction of electrical transmission losses due to increased aluminum conductor cross section. For a small additional cost as according to the US National Renewable Energy Laboratory document from contract No. DE-AC36-99-G010337 cited above, the towers of the turbines can be modified to act as fuel gas storage tanks at moderate pressure, enabling the fuel to be purchased and stored at optimum prices at several points along the line and transported to the generators for only the incremental cost of compression above the delivery pressure. Each tower can store approximately enough fuel to supply a 1.5 megawatt gas turbine 40 hrs per week for several weeks depending on tower wall thickness. A transmission line constructed in this manner is an ideal means of transporting electrical power from a mine-mouth or underground gasifier coal fired generating station in the midwest to the heavy load centres of the midwest or the west coast, since the distances are large, fuel gas is readily available at the coal beds or along the route, and wind conditions along the route are often ideal for wind turbines.

In a second embodiment of the present invention, all is constructed according to the first embodiment described above except the supplemental gas turbine engine connected to the wind generator is replaced by bidirectional hydrogen fuel cells such as the Proton Exchange Membrane cells manufactured by ProtonEnergy Inc. The weight of these fuel cells in current technology means they must be installed at ground level, and switching from natural gas to hydrogen reduces the capacity of the pipes on a megawatt thermal per hour basis to 79% of that stated above, but there would also be benefits. First, as electrolyzers the units are capable of producing the hydrogen fuel required for peaking at or near pipeline pressure, significantly reducing compressor costs and losses. Second, the fuel cells are capable of producing more hydrogen than would be required for peaking generation and the transmission lines are capable of delivering this excess economically to market points along the transmission line, thus providing a secondary market for offpeak electricity produced by the power station at the end of the line.

In a third embodiment of the present invention, the high voltage electric power is transmitted as three phase Alternating Current. All other aspects of the transmission system are the same as in the first or second preferred embodiments described previously. The tower height needs to increase in this case in order to maintain required phase clearances, and percentage electrical losses for a given transmission distance increase depending on the voltage chosen, but in other aspects the system is simplified by requiring only a simple transformer to deliver the electricity generated by the wind turbines to the primary conductors and potentially enabling the wind turbines to provide needed reactive VARS to support the transmission lines under central automated control.

In all embodiments of the present invention, the designer may choose to lay out the path of the vertical supporting towers in a catenary curve between tension towers e.g. approximately every ten towers, with the bow of the curve facing away from the prevailing wind direction. This allows the tension on the conductors to assist the towers in resisting the added horizontal loading of wind forces on the conductors from all wind directions except opposite to the prevailing direction, thus enabling the engineer to safely reduce the amount of additional support required over a standard wind turbine tower, provided the controls of the wind turbine reduce or stop wind power generation if the wind direction changes to opposite the prevailing direction. Typical wind rose maps indicate that in most locations this strategy will only reduce net wind generated power by a very small percentage. Calculations indicate that for a DC transmission line with 2 sets of four nominal 125 mm (5 inch) tubes strung in a horizontal pattern, the horizontal wind loading of the tubes on the tower in a 45 meter per second wind (100 mph) would be approximately double the loading of a 1.5 megawatt wind turbine at full power. Whether the engineer chooses to construct the towers to handle all possible loads directly, and incidentally increase the fuel storage pressure capability of the towers, or use conductor tension to mitigate part of the loads would depend on the circumstances of particular installations or even particular spans of towers.

### BRIEF DESCRIPTION OF THE SEVERAL VIEWS OF THE DRAWING

In drawings which illustrate embodiments of the invention,

FIG. 1 is an end view of a transmission line at a tower constructed according to a first preferred embodiment of the invention which carries a HAWT turbine.

FIG. 2 is an end view of a transmission line at a tower constructed according to a first preferred embodiment of the invention which carries a VAWT turbine.

FIG. 3 is a detail of the crossarms of the tower of FIG. 1.

FIG. 4 is a detail of the fuel gas pipe connection to the conductors of the tower of FIG. 1

FIG. 5 is a side view of a transmission line showing two towers which carry HAWT turbines and which are constructed according to a first preferred embodiment of the invention.

FIG. 6 is a side detail of a system of supporting the primary conductors of FIG. 1 at a non-strain line pole.

FIG. 7 is a detail, and FIG. 8 is an enlarged detail of one means of termination of the primary conductors of FIG. 1 at a strain point or corner pole.

FIG. 9 is a detail of an alternate means of termination of the primary conductors of FIG. 1 at a strain point or corner pole.

FIG. 10 is a detail of the wind turbine gearbox of FIG. 1 showing an auxiliary heat engine.

FIG. 11 is an alternative configuration of the detail of the wind turbine gearbox of the wind turbine installation of FIG. 1

FIG. 12 is a detail of the base of a transmission and generator tower constructed according to a second preferred embodiment of the invention showing the Proton Exchange Membrane fuel cell auxiliary power units.

FIG. 13 is a layout of a line of transmission and generator towers installed in a straight line between strain supporting towers.

FIG. 14 is a layout of a line of transmission and generator towers installed in a catenary curve or arc between strain supporting towers.

FIG. 15 is an end detail of the crossarms of a transmission and generator tower constructed according to a third embodiment of the invention showing three phase alternating current primary conductor tubes and underhung secondary conductors.

FIG. 16 is a detail cross section of the conductors of a transmisssion line formed of conductive walled tubes having auxiliary heating conductors installed with the primary conductors.

FIG. 17 is a detail cross section of the conductors of a transmisssion line formed of conductive walled tubes having an alternate means of heating the conductors.

FIG. 18 is an electrical schematic of one means of simultaneously heating the conductors of an operating DC transmission line.

FIG. 19 is a detail of one means of temporarily connecting the primary conductor tubes of FIG. 1 to the tensioning jacks or cable winch at a strain point or corner pole.

FIG. 20 is a second detail of one means of temporarily connecting the primary conductor tubes of FIG. 1 to the tensioning jacks or cable winch at a strain point or corner pole.

FIG. 21 is an enlarged detail end view of the system of FIGS. 19 and 20.

### DETAILED DESCRIPTION OF THE INVENTION

In all embodiments of the invention shown in Figures, like elements are referenced in different figures by the same number.

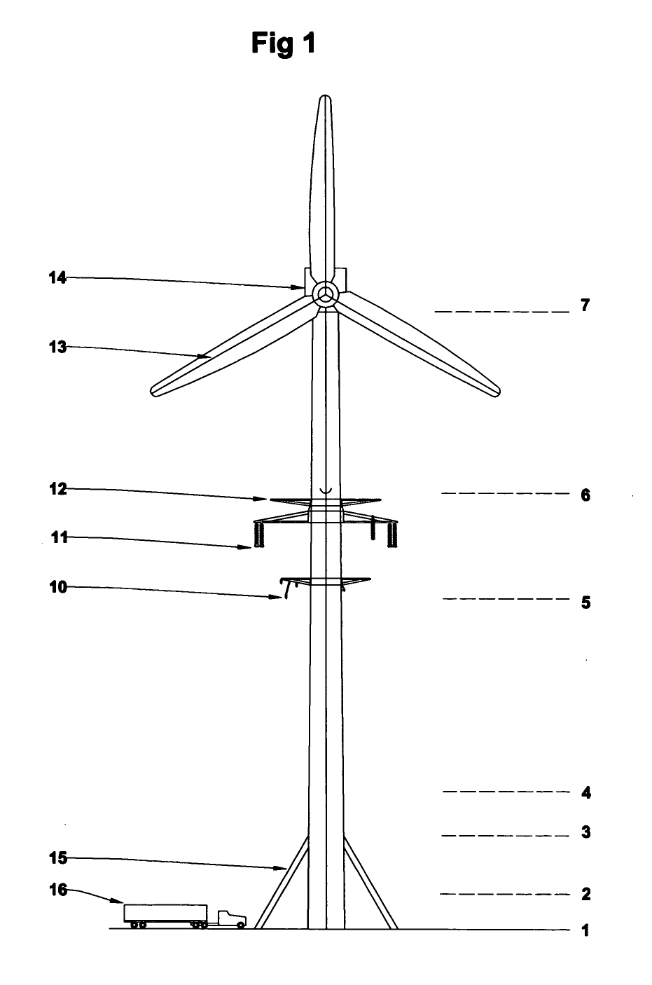

FIG. 1 is an end view of a DC transmission line at a tower which carries a HAWT turbine. The dimensions shown are based on a modern 1.5 megawatt wind turbine having 72 meter diameter blades. This turbine is typically installed on an 82 meter tall tower, which is the distance from level line 4 to level line 7 in the drawing. Level line 2 indicates the top of an expected intrusion zone at 6 meters above grade 0 meters at level line 1. Level line 3 indicates the bottom of the secondary conductor sag between towers at 16 meters above grade. Level line 4 noted above marks the length of tower extension required due to the transmission system and is 23.5 meters above grade, making the total tower height 105.5 meters. Level line 5 at 56.5 meters above grade marks the high point of the lowest secondary electrical conductor 10 suspended on the tower, indicating a line sag of 40.5 meters or 9% of a 450 meter tower interval. Level line 6 indicates the lowest point of the turbine blades 13 during their rotation, 1 meter above the skywire mounting 12. At 11 is indicated the mounting of the primary electrical conductor tubes. At 14 is the turbine gearbox, generator and auxiliary engine housing. Depending on local conditions, it may be effective to add additional supports 15 to the base of the tower to handle wind loading added by the conductor tubes. Differing local regulations, design optimizations for varying economic ends, and artificial or natural terrain variations may require adjustment of these figures. At 16 is shown, for scale reference, a typical 12.8 meter long semi-trailer truck.

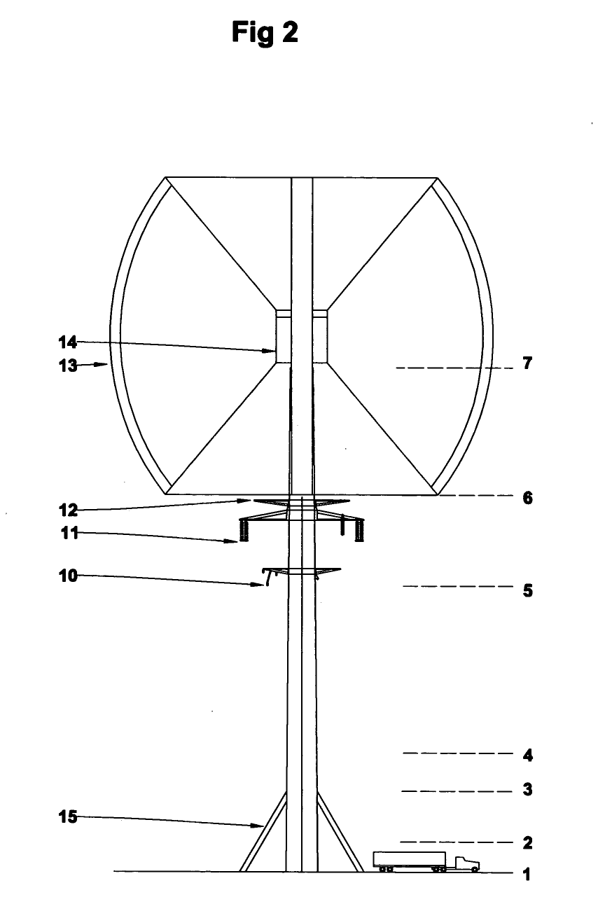

FIG. 2 is an end view of a DC transmission line at a tower which carries a Vertical Axis Wind Turbine or VAWT such as is constructed by Dermond Inc which vertical axis wind turbine blades sweep an equal area to those of the horizontal axis wind turbine of FIG. 1. All parts and dimensions up to the skywire mounting 12 are the same as in FIG. 1, but due to the difference in blade configuration, the height of the tower can be reduced by at least 6 meters, bringing the total to less than 100 meters.

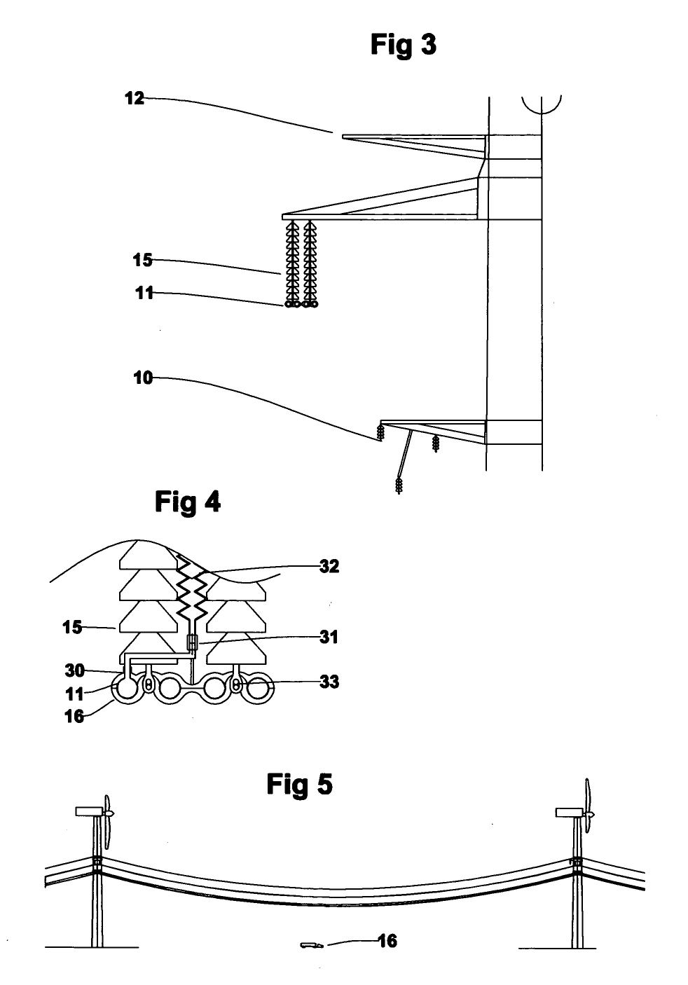

FIG. 3 is an end detail of the crossarms of the tower of FIG. 1 or FIG. 2. The underhung secondary electrical conductors shown at 10 are illustrated as Aluminum Conducter Steel Reinforced (ACSR) standard transmission cable, in this illustration configured to carry 30 Kv AC. The primary electrical conductor tubes, shown at 11 and supported by insulators 15, are configured in this Figure to carry the negative side of a 1 MV DC circuit (500 KV negative from ground one side, 500 KV positive from ground on the other side) on a set of insulators such as would be used for a 345 KV AC transmission line. The electrical conductors themselves are shown as 4 runs of 140 mm (5 inch nominal) tube having a wall thickness of 1.5 mm of 330,000 kpa yield strength aluminum alloy, thus offering a circuit DC resistance of 0.01727 ohms/km. The conductor tubes are additionally supported by steel saddles and 4×50 square mm section steel cables directly connected to the supporting insulators, resulting in a slightly higher breaking strength per suspended kg of the system than a typical ACSR cable. Additional lighter support sharing fittings (not shown) are installed at intervals between the supporting towers to transfer supported mass from the conductor tubes to the steel cables. A skywire 15 follows above the entire transmission line to eliminate the possibility of damage to the tubes by a lightning strike.

FIG. 4 is a detail of the fuel gas pipe connection to the conductors of the tower of FIG. 3. Shown is an end view detail of the saddles 16 which support the conductor tubes 11 at the insulators 15. At 30 is shown a 20 mm access tube which has been connected by welding or other means during construction to one of the several conductor tubes at the tower. A quick connect fitting 31 of construction comparable to that typically used on a hydraulic pressure hose connects this tube to a section of access pipe 32 constructed as a hollow labarinth from an insulating material such as Fiber Reinforced Polyester etc. The track length along both the outside and the inside surfaces of this section are sufficient to ensure electrical isolation of the conductor tubes from ground. Once this section of access pipe has ensured electrical isolation of the main tub s from the grounded tower, it may change to any standard fuel gas pipe to communicate with a storage system, a compressor system or an engine system, depending on the particular design of an individual tower.

FIG. 5 is a side view of a transmission line showing two towers which carry HAWT turbines and which are constructed according to a first preferred embodiment of the invention having the towers with 72 meter diameter wind HAWT's spaced at 450 meter intervals, or 6.25 diameters, which is well within the 5 to 9 diameter intervals recommended by most manufacturers. At 16 is shown, for scale reference, a typical 12.8 meter long semi-trailer truck.

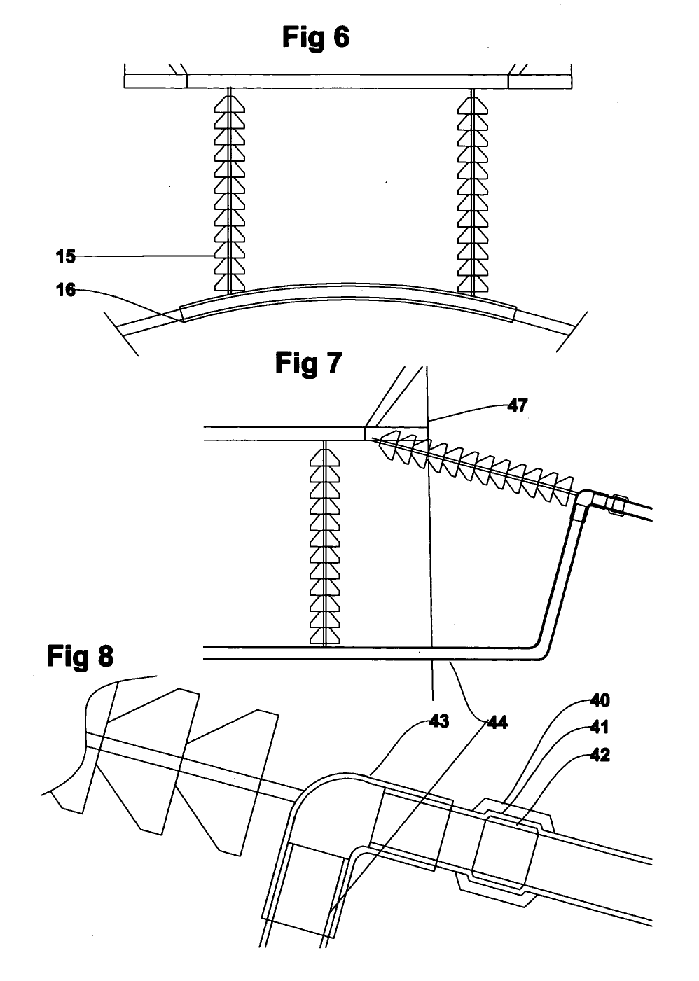

FIG. 6 is a side detail of a system of supporting the primary conductors of FIG. 1 at a non-strain line pole. The auxiliary support steel cables 33 are clamped by bolts to the insulators 15, while a steel or other suitabley manufactured saddle 16 also attached to the insulators supports the suspended weight of the tubes

FIG. 7 is a detail, and FIG. 8 is an enlarged detail of one means of termination of the primary conductors of FIG. 1 at a strain point or corner pole 47. The conductor tubes, being previously cut to the correct length, have had clamped about their outer diameter a strong fitting 40 whose edges match the normal outside diameter of the tube and whose interior part provides a cavity 41 into which the tube may be expanded. An expandable ring fitting 42, possibly of retained flat spiral spring steel or any deformable material is then installed into the tube from the end and then forcibly expanded either hydraulicaly, explosively, or by rolling or other means, thus forcing the tube to expand into the cavity 41 and leaving the expanded ring fitting 42 in place to ensure the transfer of tension forces from the tube to the clamped fitting. An elbow fitting 43 is then connected by welding, conductive adhesive or other means to connect the tube as a pipeline and as an electrical conductor to a section of tube 44 which connects the main suspended tube continuously accross the strain point to the opposite suspended tube to which it is connected in a similar manner, or to an insulating end point which connects to a primary supply or delivery point.

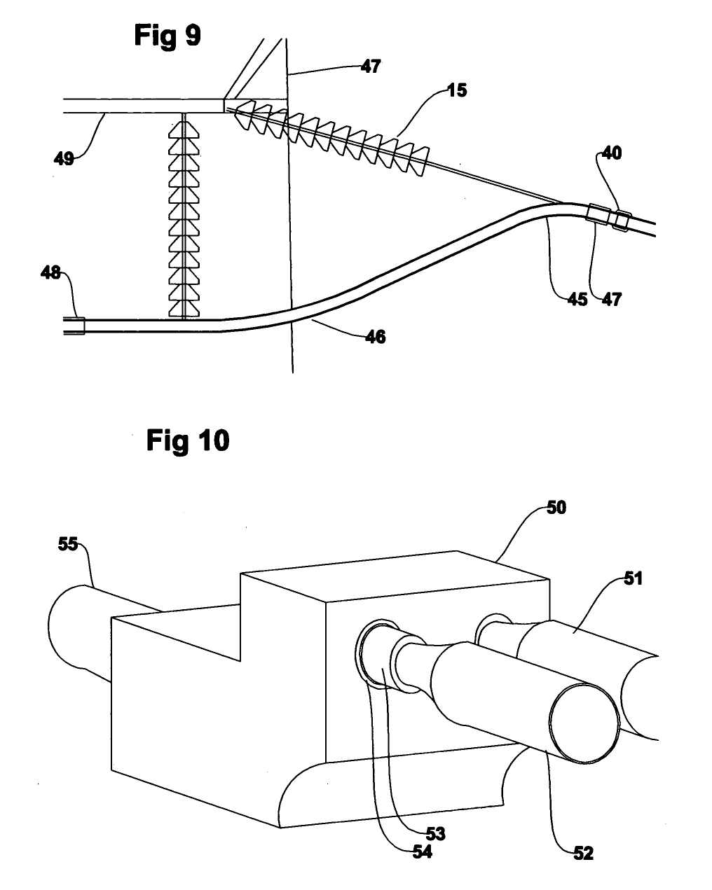

FIG. 9 is a detail of an alternate means of termination of the primary conductors of FIG. 1 at a strain point or corner pole 47. All is the same as in FIGS. 7 and 8 except the position of the clamping device 40 is moved far enough away from the insulator 15 to allow field bends 45 and 46 in the connecting tube to bypass the crossarm 49, thus removing the flow restricting close 90 degree elbow from the line of flow in the tube. The connecting tube is joined to the suspended tube by welding, conducting adhesive or other means at a logical point with fitting 47 or 48.

FIG. 10 is a detail of the wind turbine gearbox 50 of the wind turbine installation of FIG. 1 showing a typical generator 51 mounted to the standard primary generator connection point, and an auxiliary heat engine 52 and a speed matching gearbox 53 mounted to one of the standard secondary gererator mounting points 54 typically provided on wind turbine gearboxes. The wind turbine hub mounts to the wind turbine gearbox input shaft 55. The auxiliary heat engine may be any prime mover capable of sufficiently suplementing the power output of the wind turbine during periods when customer electrical demand exceeds net wind power and primary generating station productivity, or at times when an A/C transmission line to which the said wind turbine generator is connected may require more reactive VAR support than can be provided by available wind power to the wind turbine.

FIG. 11 is an alternative configuration of the detail of the wind turbine gearbox 50 of the wind turbine installation of FIG. 1 having both the typical generator 51 and the heat engine 52 mounted to a common speed matching gearbox 56, which then connects to the wind turbine gearbox 50 The wind turbine hub mounts to the wind turbine gearbox input shaft 55. This embodiment of the invention thus reduces by a small amount the transmission losses incurred within the wind generator gearbox in transferring power from the heat engine to the generator. It may then optionally be economically desireable to modify the said speed matching gearbox 56 to enable it to disconnect both the heat engine and generator from the wind turbine geartrain in times of very low or very high wind, thus further increasing the system availability and efficiency during times of peak demand and out of specification available wind.

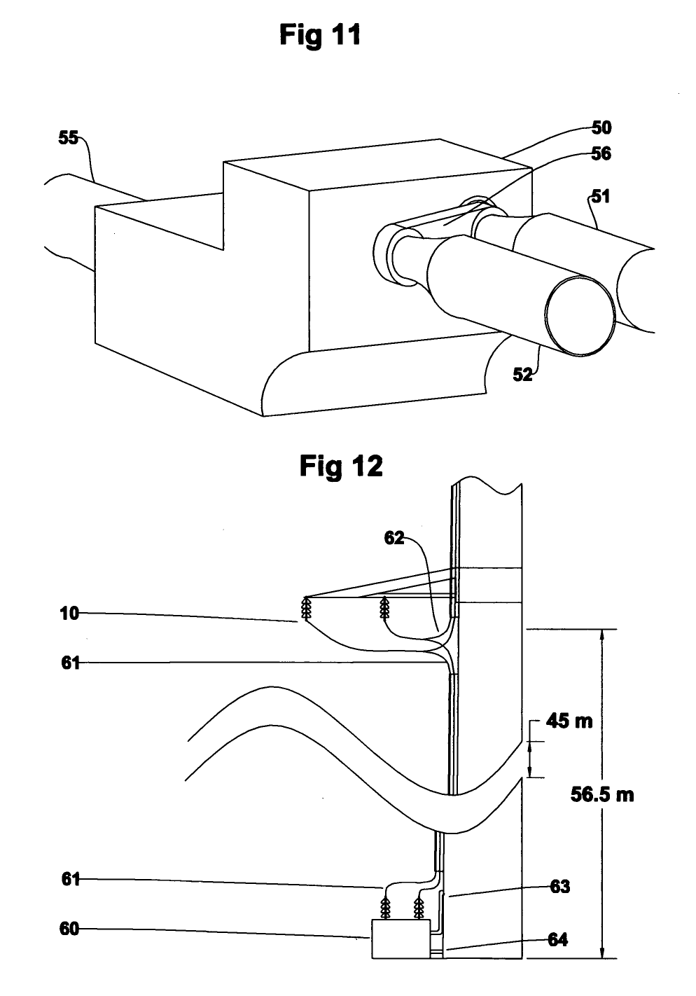

FIG. 12 is a detail of the base of a transmission and generator tower constructed according to a third embodiment of the invention showing a bi-directional fuel cell/electrolyser auxiliary power unit 60 connected electrically to the secondary conductors 10 by cable 61. The bidirectional fuel cell/electrolyser units may be Proton Exchange Membrane fuel cell/electrolysers as are manufactured by ProtonEnergy Corporation, USA, or SOFC fuel cell/electrolysers as are manufactured by several companies particularly those who were suppliers of the INEEL evaluations of this process, or any other suitable means. In this embodiment of the invention the secondary conductors are operated as DC at the rated input voltage of the fuel cell/electrolyser and generator unit, while the wind turbine, having either no auxiliary engine installed or a Rankine engine suited to waste heat recovery from SOFC electrical generation or possibly even any heat engine as in the descriptions above of FIGS. 10 or 11, simply rectifies its output power locally immediately into a DC voltage suitable for transmission by cable 62 onto the same DC secondary conductors. Neither of these two units require costly DC to AC inverter equipment for their output power, the generators on separate towers need not synchronize their AC frequency, nor do the electrolyser sections require rectification at their inputs. At a logical collection point on the power line, for example each twentieth pole, is installed a bidirectional DC-DC electronic converter (not shown) of a type such as ABB's DCLite system, capable of moving power from the low voltage secondary DC lines onto the high voltage DC primary lines or from the DC high voltage primary lines onto the low voltage DC secondary lines. This converter will be very cost effective since a) it can employ a very high frequency intermediate AC step-up voltage thus reducing significantly the cost of the AC transformation equipment b) it has no need to concern itself with the power quality or harmonics of the intermediate AC circuits. The hydrogen output of the electrolysers is piped by tube 63 directly into the storage space within the tower pole, from which during periods of peak customer electrical demand on the system it is withdrawn and supplied to the fuel cells to supplement system electrical generation, while the excess, approximately 50% of electrolyser capacity, is further compressed mechanically and supplied to the tubes which form the transmission system primary conductors for delivery and sale to customers of hydrogen, such as automobile refulers etc, along the path of the transmission line. Chemically treated pure water required for the electrolyser operation is supplied from storage near or within the base of the tower, to which it has been supplied by an alternate pipeline (not shown) or by delivery by truck or any other convenient method. Optionally pipe 63 may be continued up the pole to connect to the primary conductor tubes and possibly further up to provide fuel to a heat engine in the wind turbine nacelle. Control valves and/or a compressor (not shown) may be situated as requirements and size dictate within this circuit. All systems subject to damage by ambient weather conditions are suitable protected (not shown).

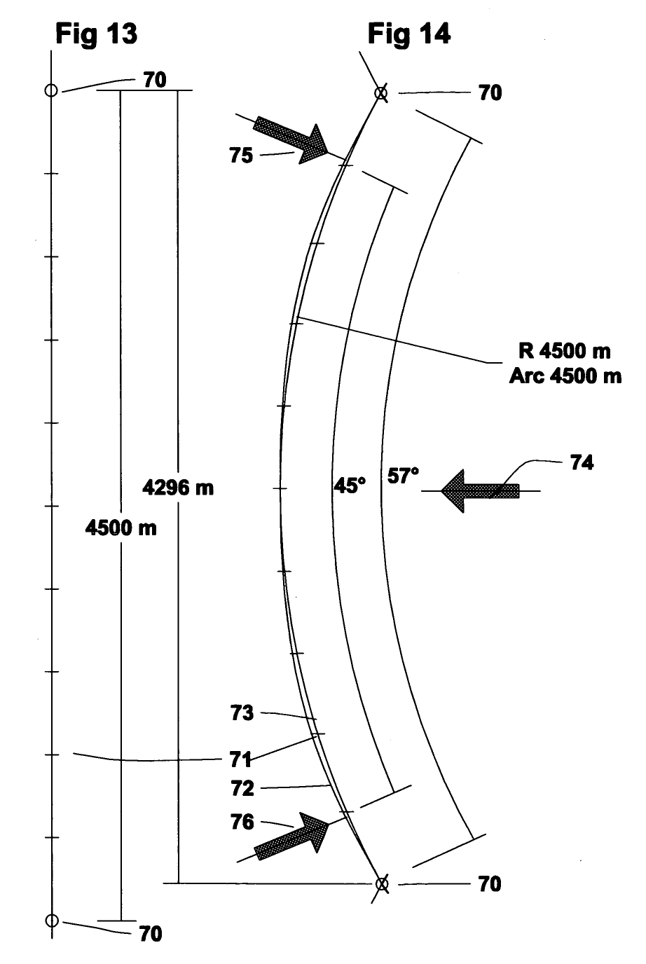

FIG. 13 is a layout of a line of 10 spans of transmission line and nine wind generator towers 71 installed in a straight line at 450 meter intervals between two supporting strain towers 70. The circles indicating the strain towers at 70 are exaggerated in scale by a factor of at least 10. The crossing lines 71 are scaled to indicate the full extent of 72 meter diameter turbine rotors. As can be seen, this installation needs to use towers at each point which are capable of withstanding wind loads from both sides at right angles to the line entirely equal to the full wind load on the turbine and on the conductor tubes, meaning the tower structures need to be quite heavy. Also if cable guys are to be used to assist in holding the strain on the conductor tubes at the strain towers they must be exactly aligned with the line for maximum effect which means they cannot contribute to supporting the towers horizontally.

FIG. 14 is a layout of a line of transmission and generator towers 71 installed in a horizontal catenary curve 72 or an arc 73 of radius equal the distance between the two supporting strain towers 70. The circles indicating the strain towers at 70 are exaggerated in scale by a factor of 11. This layout takes advantage of the fact that in most locations, as can be determined on typical wind rose maps, a design basis wind force will almost always blow from a prevailing direction, in this case indicated by wind direction arrow 74, while rarely if ever blowing from an opposite direction plus or minus 22.5 degrees, as indicated by wind direction arrows 75 and 76. By using a curved transmission line layout as indicated, the tension of the suspended conductors is easily transferred to heavy cable guys at the strain poles. But these guys and the conductor tension also provide a preload strain on the wind tower poles equal in the example illustrated to cos(5.7)*total conductor tension strain, since at each pole the suspended conductors change angle by 5.7 degrees. For a useful example implementation of the present invention, this amount is approximately half the total horizontal force exerted by the wind on the 1.5 megawatt wind turbine at full output, meaning that when the wind is driving the turbine at peak output the standard tower still has a reserve of horizontal strain capability to withstand the horizontal wind forces on the suspended transmission conductors. As wind speeds increase from there, it is already normal to shut down the wind turbine, thus reducing horizontal load on the tower, and from the prevailing wind direction this design can withstand a maximum wind force limited only by the tension strength of the conductors, their supporting cables and the strain guys. In the rare event of a very high wind from opposite the prevailing direction, the wind turbine controls are programmed to shut down the wind turbine at much lower wind speeds, allowing the towers to employ all their horizontal load capability to withstand the wind load and the cable preload. This strategy will hardly reduce the net annual output of the wind turbine at all since the wind event is very rare. If further horizontal load capability is required from opposite prevailing wind direction some additional small reacting guys may be employed at some or all of the towers within the curve. This strategy therefore safely allows much reduced tower horizontal strain design capability and therefore reduced cost of the towers while, in the particular case illustrated, adding only 4.53% to the length of the line (4500 meters of line covering only 4296 meters straightline distance). Alternatively the designer may take advantage of the reduced horizontal forces on the towers to increase the height of the towers sufficiently (approximately two meters) to allow a 4.53% increase in span length (470 meters instead of 450 meters) to provide for the increased length without increasing the number of towers. The added length of conductors, while adding a small amount to the capital cost of the transmission line, has only a very slight effect on losses on a transmission line constructed according to the first embodiment of the present invention since the said conductor tubes, in order to handle an optimal fuel gas transmission pressure and volume will have a significantly larger cross section of conductive aluminum than is usually provided for electrical conduction alone. For example a 500 Kv±DC line designed to transmit 2.8 megawatts between two points 1000 km apart while supplying compressed hydrogen fuel gas to 2000×1.5 megawatt bidirectional auxiliary fuel cell/electrolysers which run 25% time for peaking will operate at 1.34% transmission electrical losses and at the same time move 4,000,000 megawatt hours per year from baseload (75% time) into peak time (25% time) plus provide 3,447,437 Mw Termal per year of saleable Hydrogen at the delivery end point of the transmission line. Persons skilled in the art will see how to adjust the design figures to suit particular economic goals for a particular installation for either a DC or an AC transmission line having either cables or tubes for conductors without departing from the concept of the present invention.

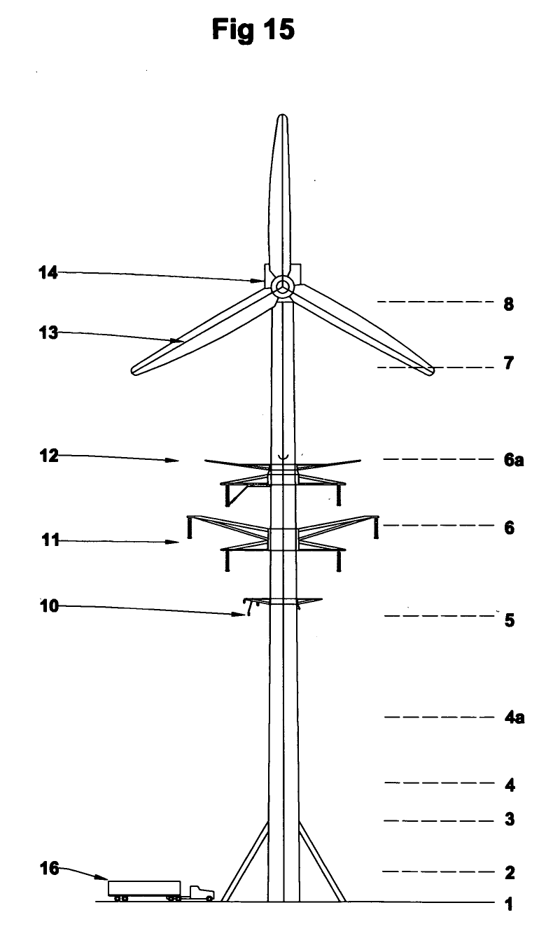

FIG. 15 is an end view of a transmission and generator tower constructed according to a fourth embodiment of the present invention showing three phase alternating current primary conductor tubes and underhung secondary conductors. All distances and indicated items are the same as in FIG. 1 but for the addition of Level line 4a which indicates the added height of this tower over a standard 82 meter tall tower of 36.5 meters, line 6a which indicates the new lowest point of the turbine blades 13 during their rotation, and line 8 which indicates the total height of the tower at 116.5 meters.

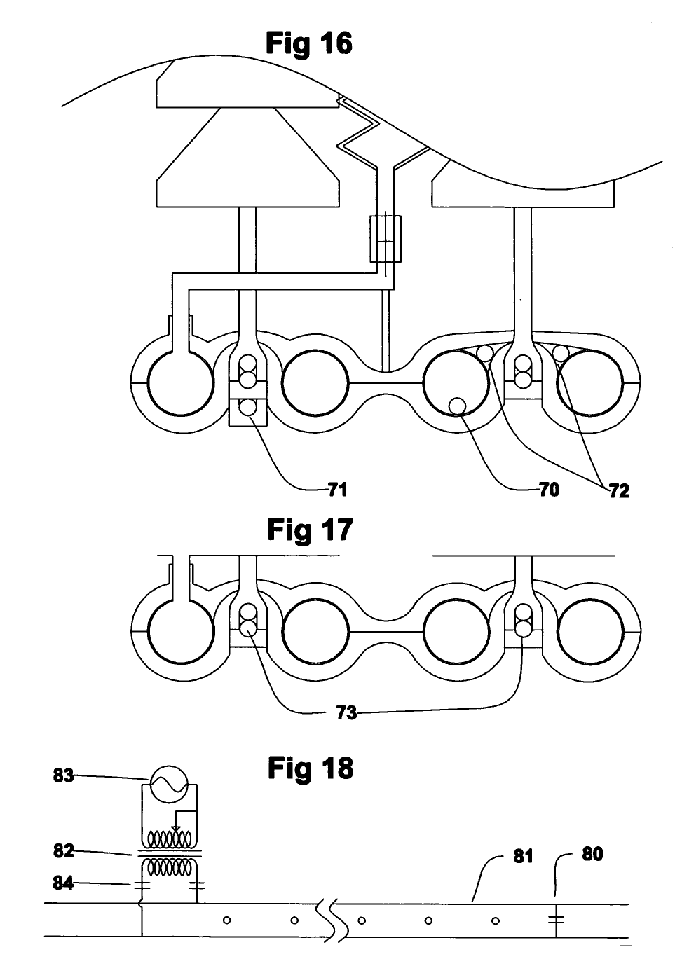

FIG. 16 is a detail cross section of the conductors of a transmisssion line formed of conductive walled tubes having installed in their interior 70 or on their exterior 71 an electrically isolated conductor of small cross section and relatively higher resistance than the main conductor tubes. At all times this conductor is electrically connected to the primary conductors at the transmitting end of the transmission line. At times when the added weight of snow or freezing rain might endanger the transmission line, a dedicated control system at the recieving end of the transmission line will selectively route an increased proportion of the transmitted current onto this higher resistance conductor by reducing the impedance of the path to the return conductors of the line relative to that of the main conductor, causing it to heat up and supply heat to the main conductor tube to the purpose of melting any accumulations of ice or snow. At all other times this heating conductor is connected electrically at both ends to the main conductors, resulting in zero potential between them. For an example 1000 km transmission line, if this conductor is comprised of a circuit of 300/50 ACSR or equivalent then if this circuit is energised at 1000 kv DC it will dissipate 1.6 kw/meter operating at 5.56 kamps, or 1.537 megawatts total.

FIG. 17 is a detail cross section of the conductors of a transmisssion line formed of conductive walled tubes having their auxiliary steel supporting cables 73 electrically isolated from the main conductor tubes thus taking advantage of the relatively higher resistance of these steel cables than the main conductor tubes to operate as line heaters in the event weather conditions may require it. Operation is the same as described for FIG. 16 above.

FIG. 18 is an electrical schematic of one means of simultaneously heating the conductors of a DC transmission line while still transmitting high voltage DC along the line. In this example a large capacitor 80 is connected across the two DC conductors 81 at the load end of the circuit. In times of inclement weather requiring heating of the conductors a low voltage single phase AC power supply 82 supplied by a generator 83 is connected to the conductors through a set of capacitors 84 at the supply end of the line, and a high amperage low voltage AC current sufficient to heat the conductors and melt ice or snow is applied to the lines. This strategy may be used alone with the full primary conductor resistence providing the load on the AC circuit, or in combination with any of the methods described for FIGS. 16 or 17 to avail the designer of a higher resistance, as economics of an individual transmission line design may require. As may suit the occasion, the generator 83 indicated may be replaced by an inverter or other suitable AC source.

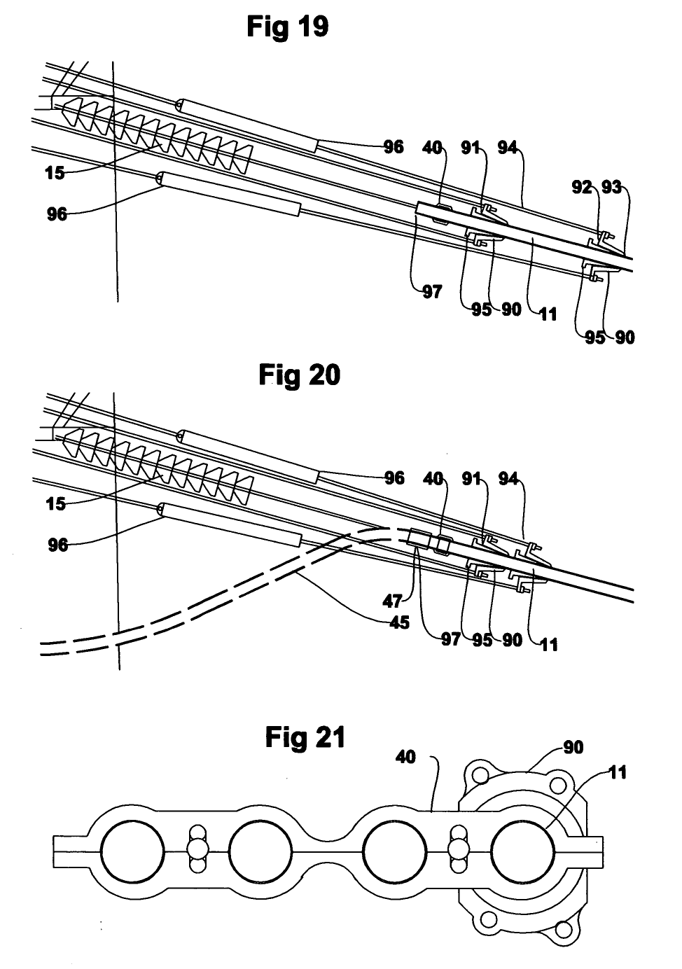

FIG. 19 is a detail of one means of temporarily connecting the primary conductor tubes of FIG. 1 to the tensioning jacks at a strain point or corner pole for the purpose of pulling the conductor tubes to sag during construction. The conductor tubes 11, being previously cut slightly longer than the required final length, have had clamped about their outer diameter two strong fittings 90 whose interior part provides a cavity 91. The said cavity is formed in tapered fashion, having a larger circumference at the end 92 toward the pulling means 94 and a reduced circumference at the end 93 away from the pulling means 94. A ring 95 formed in a matching tapered wedge and whose inner diameter is slightly less than the outer diameter of the conductor tube, is inserted into each of the resulting two cavities between the said fittings 90 and the tube. In the present illustration, one or more hyrdaulic jacks 96 provide the pulling forces, which means that a simple pressure guage can accurately measure the sag tension of the conductor tube. The jacks, here shown in their extended position, are alternately retracted and extended while the clamp fittings 90 and the wedge rings 95 are alternately moved down the tube as necessary to complete pulling the tube to tension.

FIG. 20 is a detail of one means of temporarily connecting the primary conductor tubes of FIG. 1 to the tensioning jacks or cable winch at a strain point or corner pole for the purpose of pulling the conductor tubes to sag during construction. All items are the same as in FIG. 19 but that the hydraulic jacks which implement the actual tensioning are shown in their retracted position. On achieving the required tension, the tubes are then in excellect position for final termination at the permanent strain fitting 40 and at the point of connection 97 of the tube to the next part of the line 45 with coupling means 47, according to FIGS. 7, 8 and 9, or by other means. Of course this step will wait until the strain jacks and clamps 90 are removed following permanent strain termination of the conductor tube.

FIG. 21 is an enlarged detail end view of one means of temporarily connecting the primary conductor tubes of FIG. 1 to the tensioning jacks or cable winch at a strain point or corner pole for the purpose of pulling the conductor tubes to sag during construction. The temporary tensioning clamp fittings 90 are illustrated in position to tension the rightmost conductor tube 11 for connection to permanent strain fitting 40.

While the invention has been shown and described with respect to particular embodiments thereof, this is for the purpose of illustration rather than limitation, and other variations and modifications of the specific embodiments herein shown and described will be apparent to those skilled in the art all within the intended spirit and scope of the invention. Accordingly, the patent is not to be limited to scope and effect to the specific embodiments herein shown and described nor in any other way that is inconsistent with the extent to which the progress in the art has been advanced by the invention.

1) An electrical power transmission system where the primary electrical conductors are comprised of one or more electrically conductive sealed tubes which are designed to conduct electrical energy in the tube walls and also to physically transport in quantity a useful medium within the said conductive sealed tubes along the path of the transmission line.

2) An overhead electrical power transmission system where the vertical supporting structural elements of the said system are comprised wholly or partly of towers which also support wind turbine electrical generating machines and the said wind turbines are of a type selected from the set of horizontal axis wind turbine; vertical axis wind turbine.

3) An overhead electrical power transmission system as in claim 1 or 2 having the path of the conductors between tension supports follow a catenary curve or arc with the bow of the curve or arc being as near as possible in the direction opposite the direction of the local prevailing wind.

4) An overhead electrical power transmission system as in claim 1 or 2 which incorporates at some or all of its vertical supporting structures a means of efficiently converting the potential energy of a chemical or other potential energy medium which may be supplied at pressure from the said tube of claim 1 or from storage in or near the said vertical supporting structures or from local sources; into electrical energy which is then
immediately delivered to the primary electrical conductors of the transmission system; or
transmitted along the path of the transmission line by secondary transmission conductors to one or more central stations for delivery to the primary conductors; or
supplied to a local distribution system for immediate use;
and the potential energy transfer medium is selected from the set of hydrogen gas; natural gas; methane; producer gas; water gas; vanadium oxide solution; compressed air.

5) An overhead electrical power transmission system as in claim 1 or 2 which incorporates at some or all of its vertical supporting structures a means of efficiently converting electrical energy which may be provided by
wind generators mounted on the vertical supports of the structures; or
electrical generators; fuel cells or batteries incorporated in or near the vertical supports of the structures; or
connections to the system's primary conductors; or
fossil fueled, wind or other nearby local generating systems;
into a chemical or other potential energy medium which may be supplied at pressure into the said tube of claim 1 or stored in or near the said vertical supporting structures; and the potential energy transfer medium is selected from the set of hydrogen gas; vanadium oxide solution; compressed air.

6) An overhead electrical power transmission system as in claim 4 where the means of converting the chemical or other potential energy of the said energy transfer medium into electrical energy is selected from the set of Proton Exchange Membrane fuel cell; Solid Oxide fuel cell; Alkaline fuel cell; Molten Carbonate fuel cell; Brayton cycle engine and generator; Stirling cycle engine and generator; Rankine cycle boiler, engine and generator; Diesel cycle engine and generator; Otto cycle engine and generator; Wankel cycle engine and generator; Vanadium Redox Battery cell; compressed air expander.

7) An overhead electrical power transmission system as in claim 5 where the potential energy transfer medium is hydrogen, natural gas or air which is stored at pressure in a storage tank within or near the vertical supporting structural elements of the said system and compressor means are provided to selectively move the gas
from the said conductor tubes into the said storage tank; or
from the said storage tank into the said conductor tubes; or
from the a first point on the said conductor tubes into a second downstream point on the said conductor tubes; and
the compressor means is capable of being used at times of peak electrical load on the primary conductor tubes to cool the conductor tubes by extracting the gas at pressure from the lines or from storage, compressing it to a much higher pressure than that of the conductor tubes, cooling the resulting over-compressed gas in one or more air cooled heat exchangers, then supplying or returning the overcompressed gas to the said conductor tube through a nozzle which is directed toward the direction of flow, the subsequent high velocity expansion of the compressed gas resulting in a transfer of kinetic energy to the flow and a significant cooling of the stream within the said conductor tubes and therefore the tubes themselves, so providing a means to increase the electrical carrying capacity of the said conductor tubes or to manage the thermal expansion and therefore the sag of the said conductor tubes between vertical supports.

8) An overhead electrical power transmission system as in claim 5 where the potential energy transfer medium flowing within the conductor tubes may at intervals be heated by controlled direct application of a hot gas stream to the exterior of the tube or to a portion of the flow withdrawn from the tube and then returned; to the purpose of reducing or eliminating the buildup of ice or snow on the conductor tubes in adverse weather conditions.

9) An overhead electrical power transmission system as in claim 5 where the conductor tubes or the potential energy transfer medium flowing within the conductor tubes may be heated by one or more high resistance insulated conductors installed within or in thermal contact of the said tube and an endpoint control is connected to the said insulated conductor at each end of the transmission line capable of occasionally selectively routing part or all of the transmitted electrical current onto the said insulated conductors causing them to uniformly provide heat to the said main conductor tubes; to the purpose of reducing or eliminating the buildup of ice or snow on the main conductor tubes in adverse weather conditions.

10) An overhead DC electrical power transmission system as in claim 1 where the conductors may be heated by inserting a high amperage alternating current onto the main conductors or a parallel set of electrically isolated auxiliary conductors through a set of capacitors at the inserted end and a shorting capacitor at the load end, causing the said conductors to uniformly provide heat to the said main conductors; to the purpose of reducing or eliminating the buildup of ice or snow on the main conductors in adverse weather conditions.

11) An overhead electrical power transmission system as in claim 4 where a conductive or fiber optic communication cable system is installed between each vertical support means, and each vertical support means is provided with bidirectional communication means onto the said communication cable system and a unique address within the network so formed, enabling remote monitoring and command and control of the systems installed at each said vertical support means.

12) An overhead electrical power transmission system as in claim 3 where the permanent means of clamping a tube at a point of tension strain consists of 2 parts; first a placeable clamp means having a system of bolts or other fasteners to fix it to the exterior circumference of the said tube, having means to connect to the tension holding insulaters, and having an enlarged interior circumference for the part of the clamp means nearest the tension holding insulator means and; second an insertable expandable ring system capable of being inserted inside the said tube to a point matching the enlarged circumference of the clamp means from an open end of the said tube, and then forcibly permanently expanded, so forcing the tube walls to enlarge within the said clamp means and therefore to retain the said tube within the said clamp means in tension without reducing significantly the internal section area of the said tube.

13) An overhead electrical power transmission system as in claim 3 where the temporary means of clamping a tube to pull the tub to sag at a point of tension strain consists of 4 parts; first 2 placeable clamp means each having a system of clips or other quick fasteners to fix them to the exterior circumference of the said tube, each having means to connect either to the tension pulling system of jacks or cables, or to the fixed structure of the vertical support means, and each having an enlarged interior circumference which tapers from the end of the clamp means nearest the tension pulling means at the larger circumference toward the end of the clamp toward the span at the lesser circumference and; second two insertable tapered wedge rings designed to clamp tightly by friction to the said tube when inserted into the space between the said tapered placeable clamp means and the said tube without collapsing the said tube when tension is applied.

14) An electrical power transmission system as in claim 1 where the ability of the conductive tube to withstand the pressure of the medium transported within the tubular conductor is reinforced by the circumferential application of tightly wound strands of a reinforcing material selected from the list of glass fiber; aramid fiber; carbon fiber; steel; titanium; steel alloy.
